(19) United States
(12) Patent Application Publication
(10) Pub. No.: US 2016/0149187 A1
(43) Pub. Date: May 26, 2016

(54) SEPARATOR HAVING HIGH HEAT RESISTANCE, MANUFACTURING METHOD THEREOF AND SECONDARY BATTERY INCLUDING THE SAME

(71) Applicant: Samsung SDI Co., Ltd., Yongin-si (KR)

(72) Inventors: Byeonggyu CHO, Yongin-si (KR); Hyungbae KIM, Yongin-si (KR); Eungyeong LEE, Yongin-si (KR); Jinhyuk IN, Yongin-si (KR); Jonghwan PARK, Yongin-si (KR)

(21) Appl. No.: 14/918,454

(22) Filed: Oct. 20, 2015

(30) Foreign Application Priority Data
Nov. 21, 2014 (KR) 10-2014-0163724

(51) Int. Cl. H01M 2/16; H01M 2/14

(52) U.S. Cl. CPC H01M 2/1686; H01M 2/145; H01M 2/166

(57) ABSTRACT

Provided are a separator having high heat resistance, a manufacturing method thereof and a secondary battery including the separator. The separator includes a porous base layer, and a coating layer formed on at least one surface of the base layer. Here, the coating layer includes 5 wt % to 25 wt % of polyvinyl alcohol (PVA) or derivatives thereof as a first binder and 75 wt % to 95 wt % of polyacrylic acid (PAA) or derivatives thereof as a second binder.

### CROSS-REFERENCE TO RELATED APPLICATION

This application claims priority to and the benefit of Korean Patent Application No. 10-2014-0163724 filed on Nov. 21, 2014 in the Korean Intellectual Property Office, the disclosure of which is incorporated herein in its entirety by reference.

### BACKGROUND

1. Field

The present disclosure relates to a separator having high heat resistance, a manufacturing method thereof and a secondary battery including the same.

2. Description of the Related Technology

In general, a secondary battery can be repeatedly charged and discharged, unlike a primary battery that cannot be recharged. A low-capacity secondary battery is typically used for a small portable electronic device such as a smart phone, a tablet computer, or a digital camera. A large-capacity secondary battery, obtained by connecting multiple battery cells in a pack shape, is widely used as a power supply for driving a motor of an electric bicycle, an electric scooter, a hybrid vehicle, an electric vehicle, or the like.

Secondary batteries are manufactured in various shapes, for example, a prismatic shape, a cylindrical shape and a pouch shape. A secondary battery is typically constructed with an electrode assembly in which a positive electrode and a negative electrode with a separator interposed between the positive and negative electrodes as an insulator, a case accommodating the electrode assembly and an electrolyte solution.

### SUMMARY

The present disclosure provides a separator having high heat resistance, a manufacturing method thereof and a secondary battery including the separator.

The above and other objects of the present disclosure will be described in or be apparent from the following description of the preferred embodiments.

Some embodiments provide a separator including a porous base layer, and a coating layer formed on at least one surface of the base layer. Here, the coating layer includes 5 wt % to 25 wt % of polyvinyl alcohol (PVA) or derivatives thereof as a first binder and 75 wt % to 95 wt % of polyacrylic acid (PAA) or derivatives thereof as a second binder.

The coating layer may further include an inorganic layer. Here, a ratio of the first binder to the inorganic layer is in a range of 0.3 wt % to 1.6 wt %.

The coating layer may further include an inorganic layer. Here, a ratio of the first binder to the inorganic layer is in a range of 0.3125 wt % to 1.5625 wt %.

The coating layer may further include an inorganic layer. Here, a ratio of the second binder to the inorganic layer is in a range of 4.7 wt % to 5.9 wt %.

The coating layer may further include an inorganic layer. Here, a ratio of the second binder to the inorganic layer is in a range of 4.6875 wt % to 5.9375 wt %.

The coating layer may further include an inorganic layer and the inorganic layer is one selected from the group consisting of Al₂O₃, SiO₂, TiO₂, SnO₂, CeO₂, MgO, NiO, CaO, ZnO, ZrO₂, Y₂O₃, SrTiO₃, BaTiO₃, Mg(OH)₂ and combinations thereof.

The coating layer may further include an acrylic acid series dispersing agent.

The dispersing agent may be contained in an amount of 0.1% to 0.5% based on the weight of the inorganic layer.

Some embodiments provide a secondary battery including the separator described in any of the paragraphs of the summary.

In some embodiments, there is provided a manufacturing method of a separator, including preparing a binder solution including a first binder containing 10 wt % to 25 wt % of polyvinyl alcohol (PVA) and a second binder containing 75 wt % to 95 wt % of polyacrylic acid (PAA) or derivatives thereof as a second binder, mixing inorganic particles with the binder solution and dispersing to form an inorganic slurry, and coating and the inorganic slurry on a surface of the base layer and drying the same to form an inorganic layer.

Here, distilled water may further be added to the binder solution to form the inorganic slurry in a ratio of 30% to 50% more than the inorganic particles.

A ratio of the first binder to the inorganic layer may be in a range of 0.3 wt % to 1.6 wt %.

A ratio of the first binder to the inorganic layer is in a range of 0.3125 wt % to 1.5625 wt %.

A ratio of the second binder to the inorganic layer may be in a range of 4.7 wt % to 5.9 wt %.

A ratio of the first binder to the inorganic layer is in a range of 4.6875 wt % to 5.9375 wt %.

As described above, according to some embodiments, 5 wt % to 25 wt % of polyvinyl alcohol (PVA) or derivatives thereof as a first binder and 75 wt % to 95 wt % of polyacrylic acid (PAA) or derivatives thereof as a second binder are used as the binder in combination, thereby forming the separator having high heat resistance and a reduced content of water.

### BRIEF DESCRIPTION OF THE DRAWINGS

The above and other features and advantages of the present embodiments will become more apparent by describing in detail certain embodiments thereof with reference to the attached drawing in which:

FIG. 1 is a cross-sectional view of a separator according to an embodiment.

### DETAILED DESCRIPTION

Hereinafter, certain embodiments will be described in detail with reference to the accompanying drawings such that they can easily be made and used by those skilled in the art.

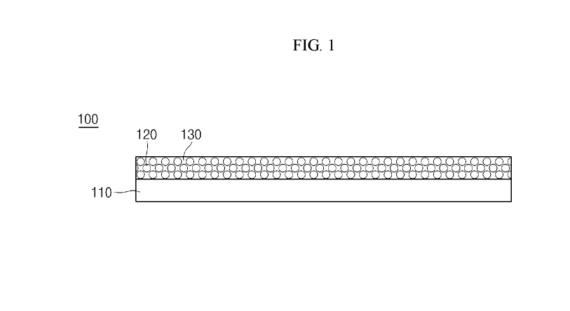

FIG. 1 is a cross-sectional view of a separator according to an embodiment.

Referring to FIG. 1, the separator 100 according to an embodiment includes a coating layer consisting of a base layer 110, an inorganic layer 120 formed on a surface of the base layer 110, and a binder 130 surrounding the inorganic layer 120.

The base layer 110 may be formed of a porous material. The base layer 110 may include, for example, glass fiber, polyester, tetrafluoroethylene (TEFLON), polyolefin, polytetrafluoroethylene (PTFE) or combinations thereof. The polyolefin may include, for example, polyethylene, polypropylene, or the like. A single layer or multiple layers of two or more layers may be used as the base layer 110. For example, a 2-layered separator of polyethylene/polypropylene, or a combined multi-layered structure such as a 3-layered separator of polyethylene/polypropylene/polyethylene or a 3-layered separator of polypropylene/polyethylene/polypropylene, may also be used as the base layer 110.

The inorganic layer 120 of the coating layer is formed on the base layer 110. The inorganic layer 120 may be made of a ceramic material capable of improving heat resistance, and examples thereof may include a metal oxide, a semi-metal oxide, a metal fluoride, a metal hydride, or a combination thereof. The inorganic layer 120 may include, for example, Al₂O₃, SiO₂, TiO₂, SnO₂, CeO₂, MgO, NiO, CaO, ZnO, ZrO₂, Y₂O₃, SrTiO₃, BaTiO₃, Mg(OH)₂, and combinations thereof. Specifically, the inorganic layer 120 may include boehmite (AlO(OH)). The inorganic layer 120 including an inorganic compound may have improved heat resistance, thereby preventing the separator from sharply shrinking or deforming due to an increase in the temperature.

The binder 130 of the coating layer may serve to allow the inorganic layer 120 to be fixed to a surface of the base layer 110 and may offer adhesion to allow the separator 100 to be well adhered to an electrode plate (not shown) of an adjacent electrode.

The coating layer may be formed on at least one surface of the base layer 110 by a general coating method. To this end, a material for forming the inorganic layer 120 and a material for forming the binder 130 are mixed with distilled water to form a slurry, and the formed slurry is then applied to a surface of base layer 110 by die coating or gravure coating. The distilled water may be added in a ratio of about 30% based on the weight of the inorganic layer 120. However, the distilled water may be eliminated when the coating layer is dried after the forming of the slurry, so that it may not remain in the final separator 100.

In order to ensure product stability, the separator 100 should maintain a minimum water content level. In addition, when the separator 100 is used to fabricate a battery, it is necessary to prevent or suppress the coating layer including the inorganic layer 120 and the binder 130 from being stripped or delaminated. Further, even when a particular event, such as an electrical short circuit, occurs to a battery cell, resulting in a rise in the internal temperature of the battery cell, heat resistance of the separator 100 should be secured. In particular, when the internal temperature of a battery cell rises to a high temperature of 200° C. or greater, there may be a high probability of battery explosion due to shrinkage and rupture of the separator 100. To avoid this, a separator having thermal stability is required.

To this end, the binder 130 may include at least two kinds of materials. The first binder of the binder 130 may include polyvinyl alcohol (PVA) or derivatives thereof. The first binder may have water-soluble, water-repelling properties. The second binder of the binder 130 may include polyacrylic acid (PAA) or derivatives thereof. The second binder may have an agglomeration property. Here, the first binder may be contained in an amount of 5 wt % to 25 wt % and the second binder may be in an amount of 75 wt % to 95 wt %. In addition, a weight ratio (% by weight) of the first binder to the inorganic layer 120 may be in a range of 0.3 to 1.6, and a weight ratio (% by weight) of the second binder to the inorganic layer 120 may be in a range of 4.7 to 5.9.

In order to prevent coagulation, the binder 130 may further include a separate dispersing agent. The dispersing agent may be contained in an amount in a range of 0.1% to 0.5% by weight, preferably in a range of 0.3% to 0.5%, based on the weight of the inorganic layer 120. The dispersing agent may be based on acrylic acid, but not limited thereto.

After forming the binder 130 in the above-described manner, the binder 130 was subjected to a rupture test. The rupture test was performed such that a 5 cm×5 cm separator was fixed on a paper frame using an imide tape and transferred to an oven, a temperature of the oven was raised up to 220° C. to then be maintained for 10 minutes, and the appearance of the separator was observed. After the rupture tests, the conventional separators were all melted, so that structures of the separators maintained were not visually confirmed. By contrast, the separator 100 according to the present disclosure maintained its structural stability even after the rupture test. In addition, the structure of the separator 100 is maintained without being shrunk or ruptured, suggesting that heat resistance of the separator 100 is improved at a high temperature and thermal stability thereof is also enhanced.

Hereinafter, effects of the separator according to the embodiment will be described by reference to the following detailed description and comparison of Examples and Comparative Examples.

### EXAMPLE 1

1500 parts by weight of boehmite AlO(OH) was used as an inorganic material for forming the inorganic layer 120, 10 parts by weight of polyvinyl alcohol (PVA2) (“PVA217”, KURARAY, Tokyo, Japan) was used as the first binder of the binder layer 130, and 90 parts by weight of a polyacrylic acid-acrylonitrile (PAA-AN) copolymer was used as the second binder of the binder layer 130. That is to say, the inorganic material, the first binder and the second binder were mixed in amounts of 93.75 wt %, 0.625 wt % and 5.625 wt %, respectively.

In all preparation steps of Examples and Comparative Examples, including Example 1, distilled water is commonly added to the binder to prepare a slurry in a ratio of 30% to 50% based on the weight of the inorganic material.

The inorganic particles were mixed and agitated at room temperature. About 2 hours after the agitating, the prepared slurry was coated to a thickness of 13 [um] and dried. Then, the ventilation, rupture test and moisture properties were evaluated.

### EXAMPLE 2

1500 parts by weight of boehmite AlO(OH) was used as an inorganic material for forming the inorganic layer 120, 25 parts by weight of polyvinyl alcohol (PVA2) was used as the first binder of the binder layer 130, and 75 parts by weight of a polyacrylic acid-acrylonitrile (PAA-AN) copolymer was used as the second binder of the binder layer 130. That is to say, the inorganic material, the first binder and the second binder were mixed in amounts of 93.75 wt %, 1.5625 wt %, and 4.6875 wt %, respectively.

### EXAMPLE 3

1500 parts by weight of boehmite AlO(OH) was used as an inorganic material for forming the inorganic layer 120, 25 parts by weight of carboxyl-containing polyvinyl alcohol (PVA4) (“KL118”, KURARAY, Tokyo, Japan) was used as the first binder of the binder layer 130, and 75 parts by weight of a polyacrylic acid-acrylonitrile (PAA-AN) copolymer was used as the second binder of the binder layer 130. That is to say, the inorganic material, the first binder and the second binder were mixed in amounts of 93.75 wt %, 1.5625 wt %, and 4.6875 wt %, respectively.

### EXAMPLE 4

1500 parts by weight of boehmite AlO(OH) was used as an inorganic material for forming the inorganic layer 120, 25 parts by weight of polyvinyl alcohol (PVA2) was used as the first binder of the binder layer 130, and 75 parts by weight of a polyacrylic acid (PAA25) having a molecular weight of 250,000 was used as the second binder of the binder layer 130. That is to say, the inorganic material, the first binder and the second binder were mixed in amounts of 93.75 wt %, 1.5625 wt %, and 4.6875 wt %, respectively.

### EXAMPLE 5

1500 parts by weight of boehmite AlO(OH) was used as an inorganic material for forming the inorganic layer 120, 10 parts by weight of polyvinyl alcohol (PVA2) was used as the first binder of the binder layer 130, and 90 parts by weight of a polyacrylic acid (PAA25) having a molecular weight of 250,000 was used as the second binder of the binder layer 130. That is to say, the inorganic material, the first binder and the second binder were mixed in amounts of 93.75 wt %, 1.5625 wt %, and 4.6875 wt %, respectively.

### EXAMPLE 6

1500 parts by weight of boehmite AlO(OH) was used as an inorganic material for forming the inorganic layer 120, 5 parts by weight of polyvinyl alcohol (PVA2) was used as the first binder of the binder layer 130, and 95 parts by weight of a polyacrylic acid-acrylonitrile (PAA-AN) copolymer was used as the second binder of the binder layer 130. That is to say, the inorganic material, the first binder and the second binder were mixed in amounts of 93.75 wt %, 0.3125 wt %, and 5.9375 wt %, respectively.

### COMPARATIVE EXAMPLE 1

1500 parts by weight of boehmite AlO(OH) was used as an inorganic material for forming the inorganic layer 120 and 100 parts by weight of a polyacrylic acid-acrylonitrile (PAA-AN), copolymer corresponding to the second binder of the binder layer 130, was used, without using polyvinyl alcohol (PVA2) of the binder layer 130. That is to say, the inorganic material, the first binder and the second binder were mixed in amounts of 93.75 wt %, Owt %, and 6.25 wt %, respectively.

### COMPARATIVE EXAMPLE 2

1500 parts by weight of boehmite AlO(OH) was used as an inorganic material for forming the inorganic layer 120, 50 parts by weight of polyvinyl alcohol (PVA2) was used as the first binder of the binder layer 130, and 50 parts by weight of a polyacrylic acid-acrylonitrile (PAA-AN), copolymer corresponding to the second binder of the binder layer 130, was used. That is to say, the inorganic material, the first binder and the second binder were mixed in amounts of 93.75 wt %, 3.125 wt %, and 3.125 wt %, respectively.

### COMPARATIVE EXAMPLE 3

1500 parts by weight of boehmite AlO(OH) was used as an inorganic material for forming the inorganic layer 120, and 100 parts by weight of polyvinyl alcohol (PVA2) was used as the first binder of the binder layer 130. However, polyacrylic acid (PAA2) corresponding to the second binder of the binder layer 130 was not added. That is to say, the inorganic material, the first binder and the second binder were mixed in amounts of 93.75 wt %, 6.25 wt %, and 0 wt %, respectively.

### COMPARATIVE EXAMPLE 4

1500 parts by weight of boehmite AlO(OH) was used as an inorganic material for forming the inorganic layer 120, 25 parts by weight of polyvinyl alcohol (PVA2) was used as the first binder of the binder layer 130, and 75 parts by weight of a polyacrylic acid (PAA0.5) having a molecular weight of 5,000 was used as the second binder of the binder layer 130. That is to say, the inorganic material, the first binder and the second binder were mixed in amounts of 93.75 wt %, 1.5625 wt %, and 4.6875 wt %, respectively.

### COMPARATIVE EXAMPLE 5

1500 parts by weight of boehmite AlO(OH) was used as an inorganic material for forming the inorganic layer 120, 25 parts by weight of acrylic emulsion binder (“TRD 102A”, JSR, Japan) was used as the first binder of the binder layer 130, and 75 parts by weight of a polyacrylic acid-acrylonitrile (PAA-AN) copolymer was used as the second binder of the binder layer 130. That is to say, the inorganic material, the first binder and the second binder were mixed in amounts of 93.75 wt %, 1.5625 wt %, and 4.6875 wt %, respectively.

### COMPARATIVE EXAMPLE 6

1500 parts by weight of boehmite AlO(OH) was used as an inorganic material for forming the inorganic layer 120, 25 parts by weight of polyvinyl alcohol (PVA2) was used as the first binder of the binder layer 130, and 75 parts by weight of “AX4518”(ZEON BIO, Japan) was used as the second binder of the binder layer 130. That is to say, the inorganic material, the first binder and the second binder were mixed in amounts of 93.75 wt %, 1.5625 wt %, and 4.6875 wt %, respectively.

Table 1 shows comparison results of Examples 1 to 6 and Comparative Examples 1 to 6.

TABLE 1

| | | | | | | | Comp. | Comp. | Comp. | Comp. | Comp. | Comp. |
|---|---|---|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 | Ex. 4 | Ex. 5 | Ex. 6 |
| First | PVA2 | PVA2 | PVA4 | PVA2 | PVA2 | PVA2 | — | PVA2 | PVA2 | PVA2 | 102A | PVA2 |
| Binder | (10) | (25) | (25) | (25) | (10) | (5) | | (50) | (100) | (25) | (25) | (25) |
| Second | PAA-AN | PAA-AN | PAA-AN | PAA25 | PAA25 | PAA25 | PAA-AN | PAA-AN | — | PAA0.5 | PAA-AN | AX4518 |
| Binder | (90) | ′(75) | (75) | (75) | (90) | (95) | (100) | (100) | | (75) | (75) | (75) |
| Inorganic | AIO(OH) | AIO(OH) | AIO(OH) | AIO(OH) | AIO(OH) | AIO(OH) | AIO(OH) | AIO(OH) | AIO | AIO | AIO(OH) | AIO(OH) |
| Material | (1500) | (1500) | (1500) | (1500) | (1500) | (1500) | (1500) | (1500) | (OH) | (OH) | (1500) | (1500) |
| | | | | | | | | | (1500) | (1500) | | |
| Thick- | 13 | 13 | 13 | 13 | 13 | 13 | 13 | 13 | 13 | 13 | 13 | 13 |
| ness | | | | | | | | | | | | |
| (um) | | | | | | | | | | | | |
| Venti- | 107 | 108 | 107 | 111 | 116 | 107 | 107 | 119 | 126 | 114 | 107 | 105 |
| lation | | | | | | | | | | | | |
| (sec/ | | | | | | | | | | | | |
| 0.1 L) | | | | | | | | | | | | |
| Rupture | OK | OK | OK | OK | OK | OK | OK | NG | NG | NG | OK | NG |
| Test | | | | | | | | | | | | |
| Water | 489 | 368 | 259 | 410 | 463 | 490 | 624 | 296 | 268 | 354 | 652 | 336 |
| (ppm) | | | | | | | | | | | | |

As shown in Table 1, the separators prepared in Examples 1 to 5 and Comparative Examples 1 to 6 demonstrated similar degrees of ventilation in ranges between 107 and 117 (sec/0.1 L). This is presumably because the coating layer has a considerably small thickness, that is, 13 [um], so that a very small deviation in the ventilation degrees was observed in the separators prepared in the respective Examples and Comparative Examples.

In the rupture tests, the separators prepared in Examples 1 to 6, Comparative Examples 1 and 5 passed (OK), while the separators prepared in Comparative Examples 2 to 4 and Comparative Example 6 failed (NG: “NOT GOOD”). As described above, the rupture test was performed such that a 5 cm×5 cm separator was fixed on a paper frame using an imide tape and transferred to an oven, a temperature of the oven was raised up to 220° C. to then be maintained for 10 minutes, and the appearance of the separator was observed.

Compared to the separators prepared in Comparative Examples 2 to 4 and Comparative Example 6, which have failed in the rupture tests, the separators prepared in Examples 1 to 6 maintained their structures as they are without shrinkage or rupture, confirming that each of the separators demonstrated improved heat resistance at a high temperature.

The water content measurement results showed that the separator prepared in Example 3 had the lowest content of water, that is, 259 ppm. A lower water content is more preferred because water contained in a coating layer may generate hydrogen (H₂) in an electrochemical reaction. Generally, it could be confirmed that the separators prepared in Examples 1 to 6 demonstrated good features in view of water contents being in a range of 259 ppm to 490 ppm. In addition, while the separators prepared in Comparative Examples 2 to 4 and 6 were better than the separators prepared in Examples in view of water contents, they failed in the rupture tests (NG). Thus, when comprehensively reviewed and considered, it may be determined that the separators prepared in Comparative Examples 2 to 4 and 6 could not be suitably used in manufacturing secondary batteries.

While the separator having high heat resistance, the manufacturing method thereof and the secondary battery having the separator according to the present embodiments have been particularly shown and described with reference to exemplary embodiments thereof, it will be understood by those of ordinary skill in the art that various changes in form and details may be made therein without departing from the spirit or scope of the present disclosure as set forth in the following claims. It is therefore desired that the present embodiments be considered in all respects as illustrative and not restrictive, reference being made to the appended claims rather than the foregoing description to indicate the scope of the disclosure.

What is claimed is:

1. A separator comprising:
a porous base layer; and
a coating layer formed on at least one surface of the base layer,
wherein the coating layer includes 5 wt % to 25 wt % of polyvinyl alcohol (PVA) or derivatives thereof as a first binder and 75 wt % to 95 wt % of polyacrylic acid (PAA) or derivatives thereof as a second binder.

2. The separator of claim 1, wherein the coating layer further includes an inorganic layer, wherein a ratio of the first binder to the inorganic layer is in a range of 0.3 wt % to 1.6 wt %.

3. The separator of claim 1, wherein the coating layer further includes an inorganic layer, wherein a ratio of the first binder to the inorganic layer is in a range of 0.3125 wt % to 1.5625 wt %.

4. The separator of claim 1, wherein the coating layer further includes an inorganic layer, wherein a ratio of the second binder to the inorganic layer is in a range of 4.7 wt % to 5.9 wt %.

5. The separator of claim 1, wherein the coating layer further includes an inorganic layer, wherein a ratio of the second binder to the inorganic layer is in a range of 4.6875 wt % to 5.9375 wt %.

6. The separator of claim 1, wherein the coating layer further includes an inorganic layer and the inorganic layer is one selected from the group consisting of Al₂O₃, SiO₂, TiO₂, SnO₂, CeO₂, MgO, NiO, CaO, ZnO, ZrO₂, Y₂O₃, SrTiO₃, BaTiO₃, Mg(OH)₂ and combinations thereof.

7. The separator of claim 1, wherein the coating layer further includes an acrylic acid series dispersing agent.

8. The separator of claim 7, wherein the dispersing agent is contained in an amount of 0.1% to 0.5% based on the weight of the inorganic layer.

9. A secondary battery including the separator of claim 1.

10. A manufacturing method of a separator, comprising:
preparing a binder solution including a first binder containing 10 wt % to 25 wt % of polyvinyl alcohol (PVA) and a second binder containing 75 wt % to 95 wt % of polyacrylic acid (PAA) or derivatives thereof as a second binder;
mixing inorganic particles with the binder solution and dispersing to form an inorganic slurry; and
coating and the inorganic slurry on a surface of the base layer and drying the same to form an inorganic layer.

11. The manufacturing method of claim 10, wherein distilled water is further added to the binder solution to form the inorganic slurry in a ratio of 30% to 50% more than the inorganic particles.

12. The manufacturing method of claim 10, wherein a ratio of the first binder to the inorganic layer is in a range of 0.3 wt % to 1.6 wt %.

13. The manufacturing method of claim 10, wherein a ratio of the second binder to the inorganic layer is in a range of 4.7 wt % to 5.9 wt %.

14. The manufacturing method of claim 10, wherein a ratio of the first binder to the inorganic layer is in a range of 0.3125 wt % to 1.5625 wt %.

15. The manufacturing method of claim 10, wherein a ratio of the second binder to the inorganic layer is in a range of 4.6875 wt % to 5.9375 wt %.
